(19) United States
(12) Patent Application Publication
(10) Pub. No.: US 2005/0284115 A1
(43) Pub. Date: Dec. 29, 2005

(54) Automobile exhaust pipe filter

(76) Inventor: Wen-Hsien Hung, Taichung Hsien (TW)

Correspondence Address: CHARLES E. BAXLEY, ESQ., 90 JOHN STREET, THIRD FLOOR, NEW YORK, NY, 10038, US

(21) Appl. No.: 10/876,895

(22) Filed: Jun. 24, 2004

(51) Int. Cl. B01D 46/00

(52) U.S. Cl. 55/485; 55/481; 55/498

(57) ABSTRACT

The present invention discloses an automobile exhaust pipe filter, which comprises a frame, being extended towards an exhaust pipe; an inner limit filter layer, being cylindrical in shape and mounted onto said frame by passing through an inner limit filter layer, a fiber filter cotton, a super-fine meshed filter layer and an outer filter layer; a rear panel, coupling tightly to an end of the exhaust pipe by a binder; and a gas inlet and a gas outlet, disposed at the exhaust pipe and its rear panel respectively, and the gas inlet and outlet are internally serrated pipes, such that the waste diesel gas discharged from the exhaust pipe is completely filtered through different filter layers before its discharge.

### BACKGROUND OF THE INVENTION

1. Field of the Invention

The present invention relates to an automobile exhaust pipe filter, more particularly to an automobile exhaust pipe filter that filters waste gases discharged from the exhaust pipe with different layers of filters to achieve the purpose of reducing air pollution.

2. Description of the Related Art

Please refer to FIGS. 1 and 2 for a prior-art automobile exhaust pipe filter. The exhaust pipe 6 comprises a plurality of pairs of limit boards 61 disposed individually on both sides of the exhaust pipe 6 and the limit board 61 has a through hole 611, and a fiber filter cotton 62 fills the gap between the limit boards 61, and the fiber filter cotton 62 does not cover up the through hole 611. The purpose of such prior-art automobile exhaust pipe filter is to allow waste gases that cannot be discharged successfully due to the oily stained gas to pass through the through hole 611. However, such design is still far from perfect, since some of the waste gas bypass the fiber filter cotton 62 without going through the through hole 611 before its discharge, and thus causing an incomplete filter even in the condition that the fiber filter cotton 62 allows the waste gas to pass through smoothly for the filtration.

### SUMMARY OF THE INVENTION

The primary objective of the present invention is to provide an automobile exhaust pipe filter to overcome the shortcoming of the incomplete filter when the waste gas is discharged from the automobile according to the prior art, so that the waste gas discharged from the automobile according to the present invention is filtered completely to reduce air pollution.

Another objective of the present invention is to provide an automobile exhaust pipe filter that can assure the validity of the filter for a long time. The present invention specially designs an easy to install or remove rear panel, so that users can open the exhaust pipe filter at a fixed schedule to clean or change the filter layer inside the exhaust pipe.

Another further objective of the present invention is to provide an automobile exhaust pipe filter that can go with an exhaust pipe of different diameters and specifications to fit the engines of different cars by one model of the filter.

To achieve the foregoing objectives, the present invention comprises:
a frame, being extended towards an exhaust pipe;
an inner limit filter layer, being cylindrical in shape and mounted onto said frame by passing through an inner limit filter layer, a fiber filter cotton, a super-fine meshed filter layer and an outer filter layer;
a rear panel, coupled tightly to an end of the exhaust pipe by a binder; and a gas inlet and a gas outlet, disposed at the exhaust pipe and its rear panel respectively, and the gas inlet and outlet are internally serrated pipes.

When a waste diesel gas produced in the combustion chamber of a motor vehicle is discharged continuously from the exhaust pipe, the waste gas or pollutant can be pre-filtered by a plurality of fiber filters and super-fine meshed filters to keep the incompletely combusted fuel and deposited carbon remained in the filter, so that the discharged gas is filtered completely to achieve the objective of reducing air pollution.

The rear panel is coupled to an end of the exhaust pipe by a binder C for an easy installation and removal of the filter. Users can open the rear panel to remove the whole set of filter at a fixed schedule to clean or replace the fiber filter or clean the super-fine meshed filter layer for repeated uses.

The gas inlet of the exhaust pipe is an internally serrated pipe for mounting an exhaust pipe of different diameters and different specification for fitting different models of cars by one model of the filter device.

### BRIEF DESCRIPTION OF THE DRAWINGS

FIG. 1 is an exploded view of the automobile exhaust pipe filter according to a prior art.

FIG. 2 is a cross-sectional view of the automobile exhaust pipe filter according to a prior art.

FIG. 3 is an exploded view of the automobile exhaust pipe filter according to the present invention.

FIG. 4 is a cross-sectional view of the automobile exhaust pipe filter according to the present invention.

FIG. 5 is an enlarged view of part of the super-fine meshed filter layer according to the present invention.

FIG. 6 is a perspective view of the automobile exhaust pipe filter according to the present invention.

FIG. 7 is a cross-sectional view of Section 7-7 as depicted in FIG. 6.

FIG. 8 is a cross-sectional view of Section 8-8 as depicted in FIG. 7.

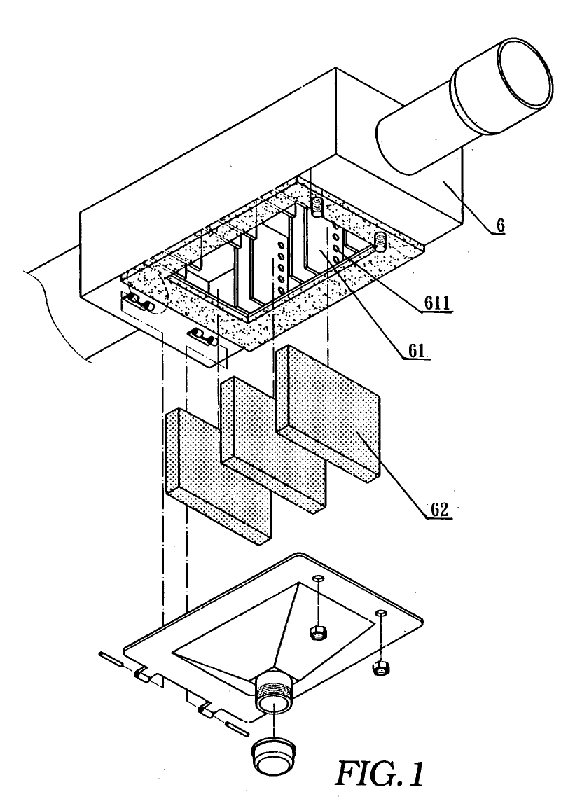

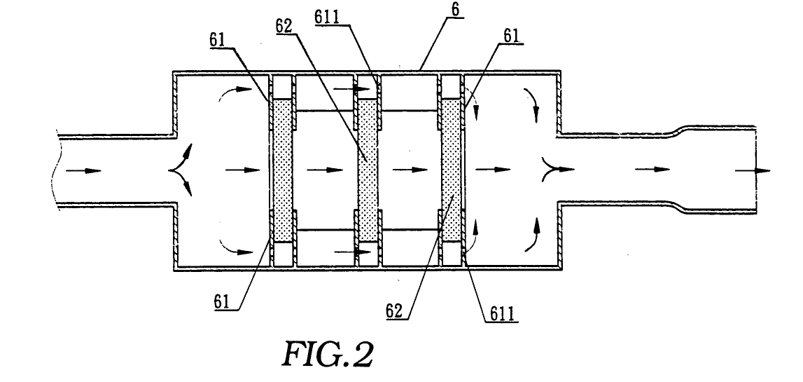

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

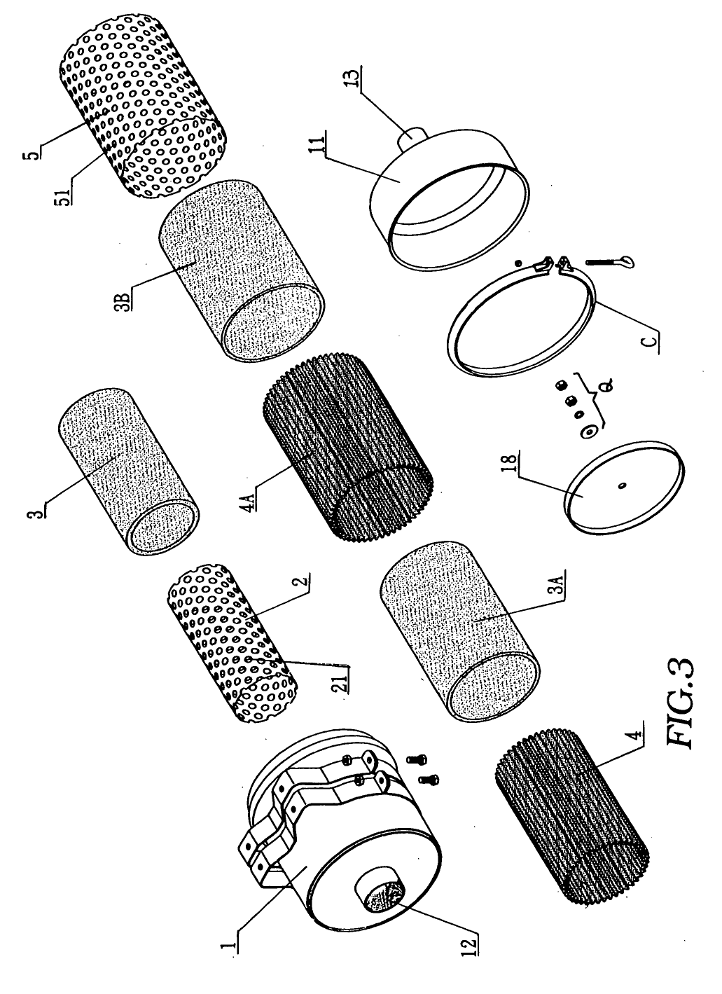

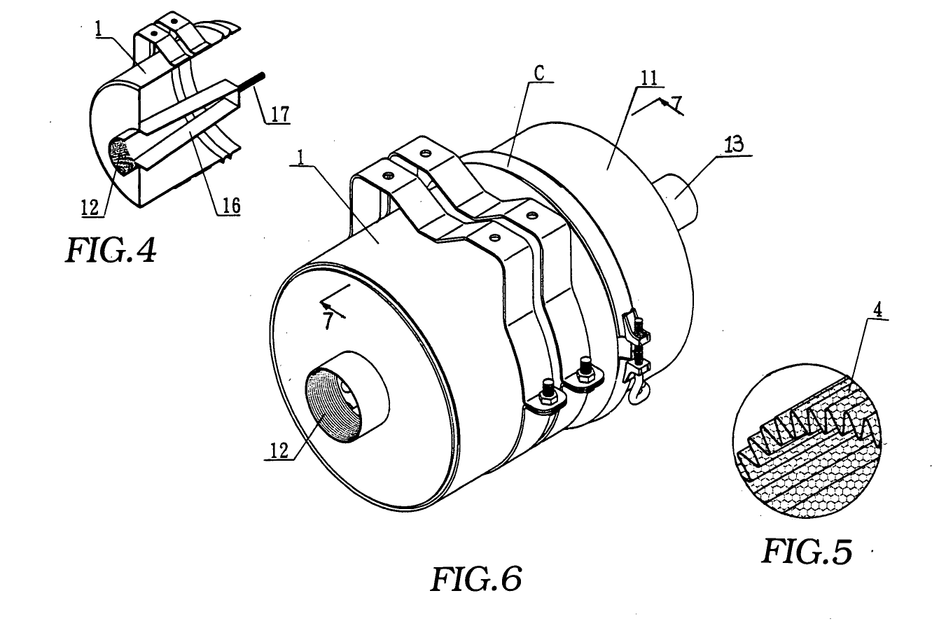

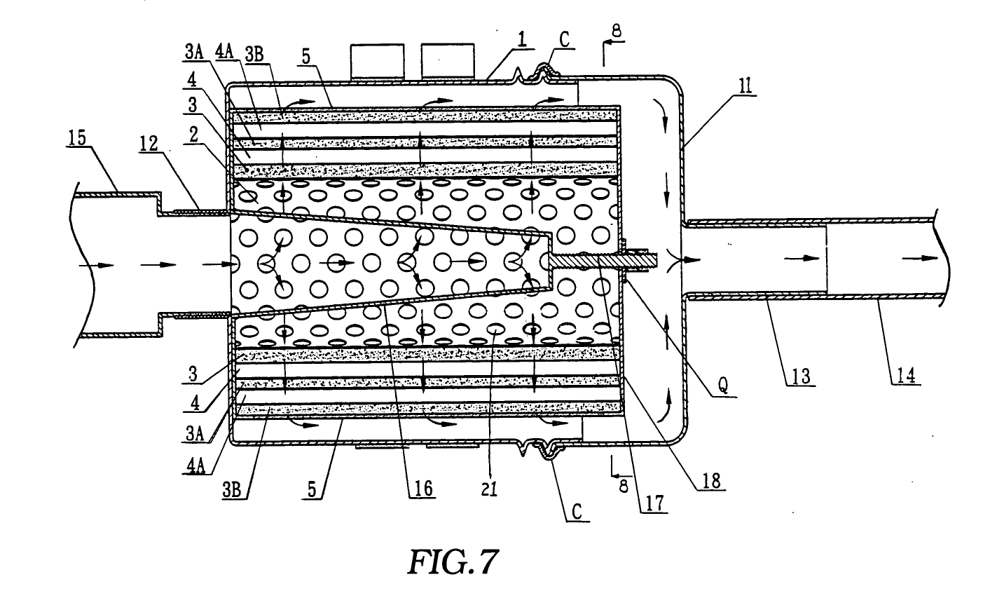

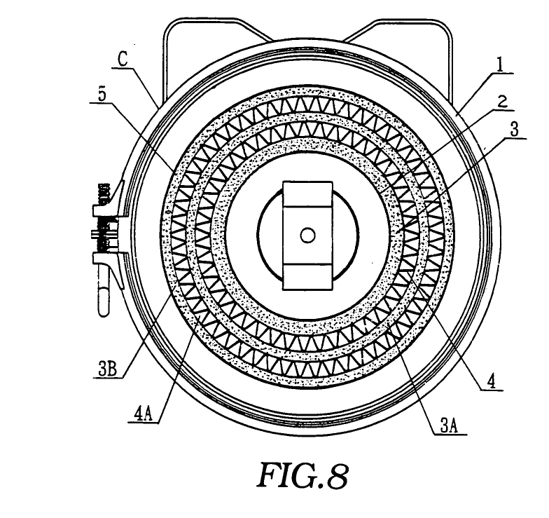

An automobile exhaust pipe filter in accordance with the present invention comprises:
a frame 16, extending towards the interior of an exhaust pipe 1, and the frame 16 has a screw rod 17 disposed at an end of the frame 16 as shown in FIGS. 4 and 7;
an inner limit filter layer 2, a first fiber filter cotton 3, a first super-fine meshed filter layer 4, a second fiber filter cotton 3A having a diameter larger than the first fiber filter cotton 3, a second super-fine meshed filter 4A having a diameter larger than the first super-fine meshed filter layer 4, and a third fiber filter cotton 3B having a diameter larger than the second fiber filter cotton 3B and an outer limit filter layer 5 as shown in FIGS. 3, 7 and 8). The inner limit filter layer 2 and the outer limit filter layer 5 are made of metal cylinders and have air holes 21, 51 thereon; the circular surfaces of the first super-fine meshed filter layer 4 and the second super-fine meshed filter layer 4A are in a serrated shape or a wavy shape as shown in FIG. 5 to increase the filtering area;
a side limit frame 18, being coupled to the screw rod 17 by a screw nut Q and wrapped by the foregoing filter layers and fiber filter cottons as shown in FIGS. 3 and 7;
a rear panel 11, coupled to an end of the exhaust pipe 1 as shown in FIGS. 3, 6 and 7, and a binder C being used for coupling the rear panel 11 with the exhaust pipe, and the exhaust pipe 1 and the rear panel 11 at their outer sides having a gas inlet 12 and a gas outlet 13 respectively, and the gas outlet 13 coupling with the outer ring of the waste gas discharge pipe 14, and the gas inlet is substantially in the form of a serrated pipe and coupled with an engine exhaust pipe 15 of different specifications by its internal serrations.

When a waste gas produced in the combustion chamber of a motor vehicle is discharged continuously out from the exhaust pipe 1, the waste gas or pollutant can be pre-filtered by a plurality of fiber filters 3, 3A, 3B and super-fine meshed filters 4, 4A to keep the incompletely combusted fuel and deposited carbon remained in the filter, so that the discharged gas is filtered completely to achieve the objective of reducing air pollution.

The rear panel 11 is coupled to an end of the exhaust pipe 1 by a binder C for an easy installation and removal of the filter. Users can open the rear panel 11 to remove the whole set of filter at fixed schedules to clean or replace the fiber filters 3, 3A, 3B or clean the super-fine meshed filter layers 4, 4A for repeated uses.

The gas inlet 12 of the exhaust pipe 1 is an internally serrated pipe for mounting an exhaust pipe 15 of different diameters and different specification for fitting different models of cars by one model of filter device.

In summation of the description above, the present invention overcomes the shortcomings of the prior-art and enhances the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements.

1. An automobile exhaust pipe filter, comprising:
a frame, being extended towards an exhaust pipe;
an inner limit filter layer, being cylindrical in shape and mounted onto said frame by passing through an inner limit filter layer, a first fiber filter cotton, a first super-fine meshed filter layer and an outer filter layer;
a rear panel, coupled tightly to an end of said exhaust pipe by a binder; and
a gas inlet and a gas outlet, disposed at said exhaust pipe and said rear panel respectively.

2. The automobile exhaust pipe filter of claim 1, further comprising a second fiber filter cotton having a larger diameter than that of said first fiber filter cotton, a second super-fine meshed filter layer having a diameter larger than that of said first super-fine meshed filter layer, and a third fiber filter cotton having a diameter larger than that of second fiber filter cotton disposed in sequence between said super-fine meshed layer and said outer limit board.

3. The automobile exhaust pipe filter of claim 2, wherein said inner limit filter layer is made of a metal cylinder having an air hole thereon.

4. The automobile exhaust pipe filter of claim 2, wherein said outer limit filter layer is made of a metal cylinder having an air hole thereon.

5. The automobile exhaust pipe filter of claim 2, wherein said super-fine meshed filter layer has a serrated circular surface.

6. The automobile exhaust pipe filter of claim 2, wherein said second super-fine meshed filter layer has a serrated circular surface.

7. The automobile exhaust pipe filter of claim 2, wherein said frame comprises a side limit frame pivotally coupled to a rear end of said frame for wrapping and fixing said filter layers and fiber filter layers.

8. The automobile exhaust pipe filter of claim 7, wherein said fame comprises a screw rod at its rear end, and the center of said side limit frame couples with said screw rod and secured by a screw nut.

9. The automobile exhaust pipe filter of claim 1, wherein said rear panel is fixed to an end of said exhaust pipe by a binder.

10. The automobile exhaust pipe filter of claim 1, wherein said gas inlet is an internally serrated pipe.
